(19) United States
(12) Patent Application Publication
(10) Pub. No.: US 2008/0041299 A1
(43) Pub. Date: Feb. 21, 2008

(54) GAGES AND DIAL INDICATORS

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: THE HOFFMAN GROUP, LLC, Portland, OR (US)

(21) Appl. No.: 11/692,186

(22) Filed: Mar. 27, 2007

Related U.S. Application Data
(60) Provisional application No. 60/743,826, filed on Mar. 27, 2006.

(51) Int. Cl. G01D 11/24

(52) U.S. Cl. 116/305

(57) ABSTRACT

Gages allowing for removable and replaceable dial, indicator needle, crystal and bezel.

### RELATED APPLICATION

This application is a non-provisional application of and claiming benefit of U.S. Provisional Application No. 60/743,826, filed Mar. 27, 2007, incorporated herein in its entirety by reference

### FIELD

The present invention is related to gages and the like, and more particularly, to gages allowing for removable and replaceable dial, indicator needle and bezel.

### BACKGROUND

Gages, also known as dial indicators, are used in various instrument panels to indicate one of any number of parameters. For example, gages used in automobiles and trucks include tachometers to indicate engine speed, speedometers to indicate vehicle speed, and various other gages for indicating temperature and pressure, fuel level, voltage, among others.

Many automobile enthusiasts consider it highly desirable to incorporate customized and personalized aesthetics into their stock or custom automobiles. Gages of various styles, configurations, and colors are available to the aftermarket enthusiast but the enthusiast is limited to market availability and available inventory. Further, once the chosen gage is installed into the automobile, there is no easy way for the enthusiast to change the aesthetics of the gage without having to disassemble the instrument panel and replace the entire gage.

These and other issues hinder the automobile enthusiast's freedom to customize and personalize the aesthetics of one or the ensemble of gages in the automobile cockpit. These issues also hinder the automobile manufacturers from providing aesthetic options to the customer leaving the customer to settle for the stock gage ensemble which may or may not be aesthetically pleasing to the customer.

It would, therefore, be highly desirable to have gages that provide automobile manufacturers, dealers, and aftermarket enthusiasts the ability to change the aesthetics of the gages without major assembly and change-out issues, inventory burdens, and high costs.

### BRIEF DESCRIPTION OF THE DRAWINGS

Like reference numbers generally indicate corresponding elements in the figures.

FIG. 1 is a perspective exploded view of a gage in accordance with an embodiment of the present invention;

FIG. 2A is a partial cross-sectional view of a gage comprising a bezel ring and a housing, in accordance with an embodiment of the present invention;

FIG. 2B is a top view of the housing of FIG. 2A;

FIG. 3 is a partial cross-sectional view of a gage comprising a bezel ring and a housing, in accordance with an embodiment of the present invention;

FIG. 4 is a perspective view of a gage comprising a bezel ring and a housing, in accordance with another embodiment of the present invention;

FIG. 5 is a perspective view of a shaft and needle, in accordance with an embodiment of the present invention;

FIG. 6 is a perspective view of a shaft and needle, in accordance with an embodiment of the present invention;

FIG. 7 is a perspective view of a needle assembly comprising a needle and a coupling post, in accordance with an embodiment of the present invention;

FIG. 8 is a perspective view of a needle assembly comprising a needle and a coupling post, in accordance with an embodiment of the present invention;

FIG. 9 is a perspective view of a gage comprising a housing and dial, in accordance with an embodiment of the present invention;

FIG. 10 is a perspective view of a gage, in accordance with an embodiment of the present invention;

FIG. 11 is a perspective view of a gage, in accordance with an embodiment of the present invention;

FIG. 12 is a side view of the dial of the embodiment shown in FIG. 11, in accordance with the present invention; and

FIG. 13 is a perspective view of a gage in accordance with an embodiment of the present invention.

### DETAILED DESCRIPTION

References will now be made to embodiments illustrated in the drawings and specific language which will be used to describe the same. It will nevertheless be understood that no limitation of the scope of the invention is thereby intended, such alterations and further modifications in the illustrated devices, as such further applications of the principles of the invention as illustrated therein as being contemplated as would normally occur to one skilled in the art to which the invention relates.

Embodiments in accordance with the present invention relate to providing gages allowing for removable and replaceable dial, indicator needle, bezel and crystal.

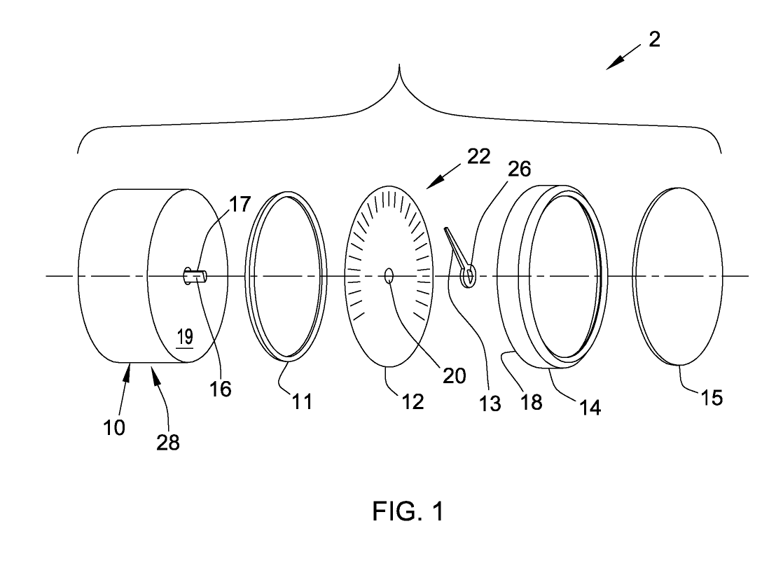

FIG. 1 is a perspective exploded view of a gage 2 in accordance with an embodiment of the present invention. The gage 2 comprises a housing 10, dial 12, indicator needle 13, bezel ring 14 and crystal 15. The housing 10 is generally cylindrical defining a face 19. The housing 10 generally houses the internal components (not shown) of the gage 2. A shaft 16 extends forwardly beyond the face 19 so that the indicator needle 13 may be coupled thereon.

A dial 12 is provided adjacent the face 19 of the housing 10. The dial 12 comprises a dial aperture 20 coaxially located with the shaft 16 so as to allow the shaft 16 to extend therethrough. The dial 12 is provided with markings 22, such as, but not limited to, graduations and sequential numbers, suitable for a particular purpose.

The indicator needle 13 is coupled to the shaft 16 such that the needle 13 may rotate relative to the dial 12 and adjacent the markings 22 upon rotation of the shaft 16 under the influence of stimuli. The needle 13 further comprises a needle coupling element in the form of a needle aperture 26 adapted to allow the shaft to extend thereon. The shaft 16 has a predetermined cross-sectional shape that is adapted to register with the shape of the needle aperture 26. The cooperation of the shape of the shaft 16 with the shape of the needle aperture 26 ensures proper alignment of the needle 13 to the shaft 16 and prevents the needle 13 from rotating relative to the shaft 16.

The crystal 15 is adapted to be constrained by the bezel ring 14 and the housing 10 when the bezel ring 14 is coupled to the housing 10. The bezel ring 14 is adapted for removable coupling with the housing 10. The dial 12 is adapted for removable coupling with the face 19, with the shaft 16 extending through the dial aperture 20.

In another embodiment in accordance with the present invention, a sealing ring 11 is disposed between the housing 10 and the bezel ring 14 so as to inhibit the infiltration of dust within the housing and/or on the dial 12 and needle 13.

In accordance with embodiments of the present invention, the bezel ring 14 is adapted for removable coupling to the housing 10, the needle 13 is adapted for removable coupling with the shaft 16, and the dial 12 is adapted for removable coupling with the face 19. These features provide the user with the ability to remove and replace the bezel ring 14 and the crystal 15, and remove and replace the dial 12 and/or needle 13, while the gage 10 remains installed in an instrument mounting or panel.

In an embodiment in accordance with the present invention, needles 13 of various aesthetically pleasing colors, shapes and configurations, and dials 12 of various aesthetically pleasing colors and markings, are provided so as to allow the user to customize and personalize the look of the gage. The easily removable bezel 14 and crystal 15 provides quick and easy access to the dial 12 and needle 13 allowing the user the change the same at any time and as often as desired.

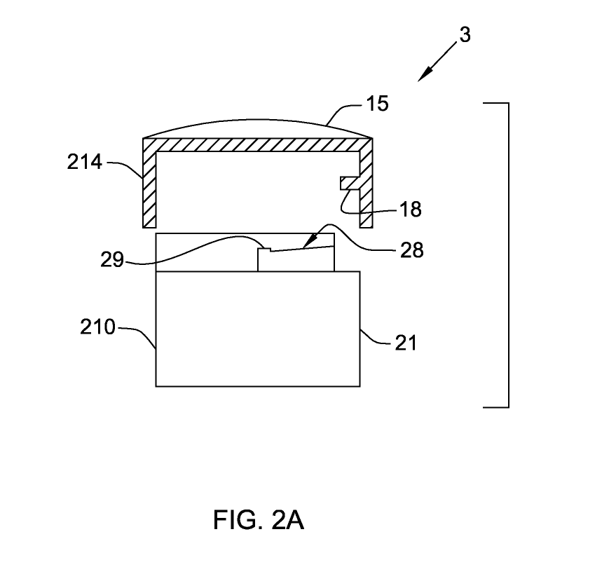

FIG. 2A is a partial cross-sectional view of a gage 3 comprising a bezel ring 214 and a housing 210, in accordance with an embodiment of the present invention. FIG. 2B is a top view of the housing 210. The housing 210 comprises an outer side 21 including at least one tapered notch 28. The bezel ring 214 comprises at least one camming element 18. The camming element 18 is adapted to engage the tapered notch 28 such that when the bezel ring 214 is rotated relative to the housing 210, the camming element 18 engages the notch 28 urging the bezel ring 214 onto and in secure removable engagement with the housing 210. Reverse rotation of the bezel ring 214 relative to the housing 210 allows for loosening and removal of the bezel ring 214 and the crystal 15 from the housing 210.

In another embodiment in accordance with the present invention, a snap notch 29, as shown in FIG. 2A, is provided in the tapered notch 28 adapted to capture the camming element 18 therein to provide removable capture of the camming element 18 therein adapted to prevent loosing of the bezel ring 214 from the housing 210.

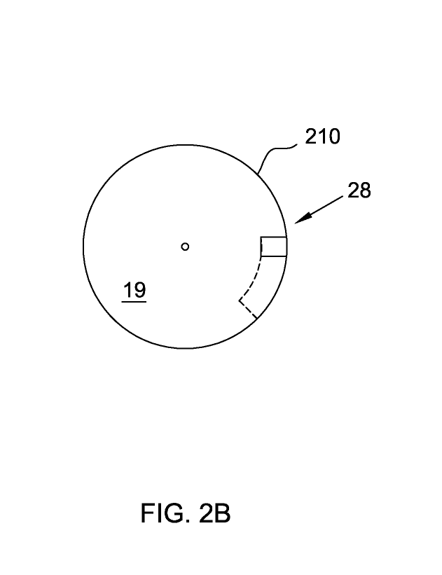

FIG. 3 is a partial cross-sectional view of a gage 4 comprising a bezel ring 314 and a housing 310, in accordance with an embodiment of the present invention. The housing 310 comprises an outer side 21 including a capture notch 34. The bezel ring 314 comprises at least one engagement element 32. The engagement element 32 is adapted to engage the capture notch 34 such that when the bezel ring 314 is pushed and urged onto the housing 310, the engagement element 32 engages the capture notch 34 in a snap-on engagement such that the bezel ring 314 is provided with secure removable engagement with the housing 310. Pulling of the bezel ring 314 relative to the housing 310 allows for un-snapping and removal of the bezel ring 314 and the crystal 15 from the housing 310.

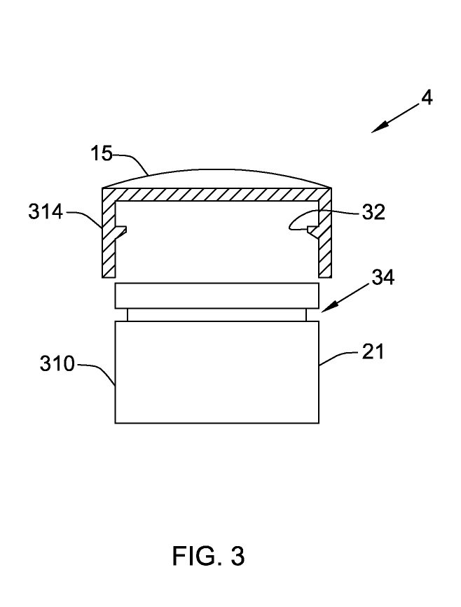

FIG. 4 is a perspective view of a gage 5 comprising a bezel ring 414 and a housing 410, in accordance with another embodiment of the present invention. The housing 410 and the bezel ring 414 are provided with threaded features 36 and 38, respectively, so as to provide threaded engagement between the two.

In embodiments in accordance with the present invention, the crystal 15 is removably coupled to the bezel ring 14, as shown in FIG. 1. Bezel rings 14 of various aesthetically pleasing colors, shapes, and markings, and crystals 15 of various shapes and tints are anticipated so as to allow the user to customize and personalize the look of the gage.

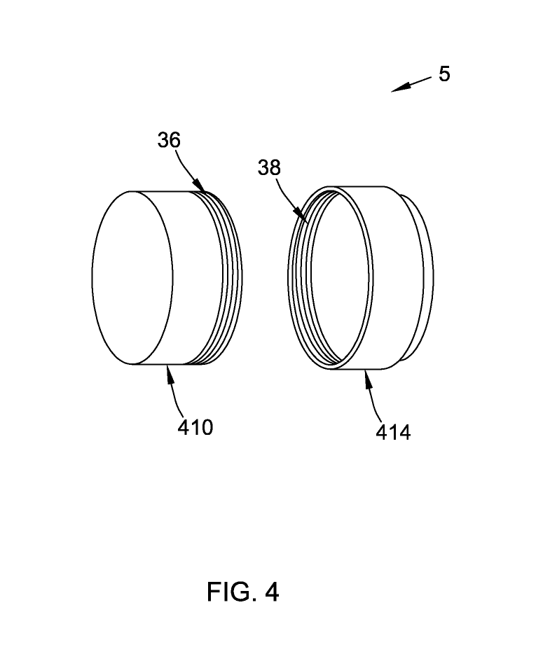

FIG. 5 is a perspective view of a shaft 516 and needle 513, in accordance with an embodiment of the present invention. The shaft 516 comprises a proximal end 517 having a “D” shaped profile and the needle 513 comprises a complimentary “D” shaped needle aperture 526 adapted to allow the shaft proximate end 517 to extend thereon. The “D” shaped shaft proximal end 517 is adapted to register in alignment with the needle aperture 526. The cooperation of the shape of the shaft 516 with the shape of the needle aperture 526 ensures proper alignment of the needle 513 to the shaft 516 and prevents the needle 513 from rotating relative to the shaft 516. A coupling element 527 is provided for coupling the needle 513 to the shaft 516. The coupling element 527 comprises a bore 523 adapted to accept and complimentary to the shaft proximate end 517 so as to extend over the shaft proximate end 517 coupling the needle 513 to the shaft 516. In an embodiment in accordance with the present invention, the coupling element 527 comprises a resilient material so as to slip onto and couple in urging engagement with the proximal end 517 of the shaft 516.

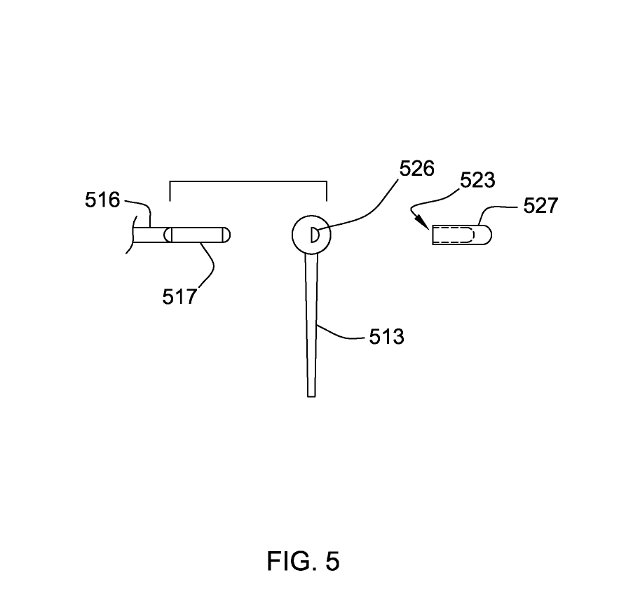

FIG. 6 is a perspective view of a shaft 616 and needle 613, in accordance with an embodiment of the present invention. The shaft 616 comprises a proximal end 617 including a groove 635 extending along the shaft 616 from the proximal end 617. The needle 613 comprises a complementary aperture 626 including a protrusion 633 adapted to allow the shaft 616 to extend therein. The groove 635 is adapted to register with the protrusion 633 of the needle aperture 626. The cooperation of the groove 635 and the protrusion 633 ensures proper alignment of the needle 613 to the shaft 616 and prevents the needle 613 from rotating relative to the shaft 616.

A coupling element 627 is provided for coupling the needle 613 to the shaft 616. The coupling element 627 comprises a bore 623 adapted to accept and complimentary to the shaft proximate end 617 so as to extend over the shaft proximate end 617 coupling the needle 613 to the shaft 616. In an embodiment in accordance with the present invention, the coupling element 627 comprises a resilient material so as to slip onto and couple in urging engagement with the proximal end 617 of the shaft 616.

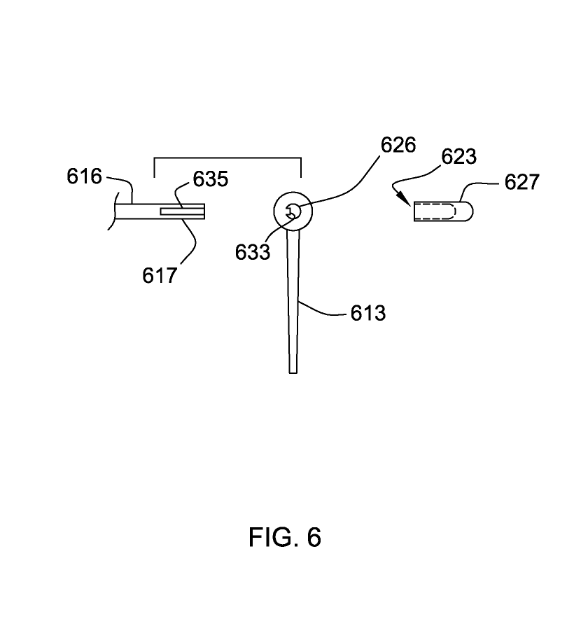

FIG. 7 is a perspective view of a needle assembly 731 comprising a needle 713 and a needle coupling element in the form of a coupling post 727, in accordance with an embodiment of the present invention. The coupling post 727 comprises a coupling element 723 adapted to couple with the shaft 16 of the housing 10, as shown in FIG. 1. In an embodiment, the coupling element is a bore 723 adapted to accept and complimentary to the shaft proximate end 17 so as to extend over the shaft proximate end 17 coupling the needle assembly 731 to the shaft 16. In other embodiments, the bore 723 is adapted to be complimentary to and register with registration elements such as, but not limited to, “D” shaped profile and groove in the proximate end 17 of the shaft 16. In an embodiment in accordance with the present invention, the coupling post 727 comprises a resilient material so as to slip onto and couple in urging engagement with the proximal end 17 of the shaft 16.

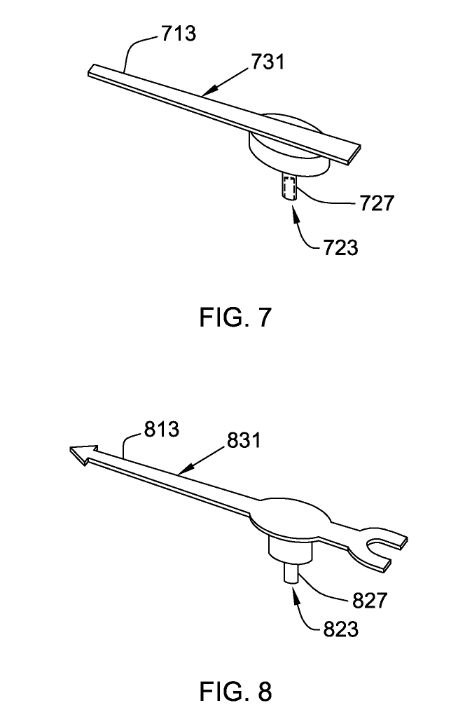

FIG. 8 is a perspective view of a needle assembly 831 comprising a needle 813 and a needle coupling element in the form of a coupling post 827, in accordance with an embodiment of the present invention. The coupling post 827 comprises a coupling element 823 adapted to couple with the shaft 16 of the housing 10, as shown in FIG. 1. In an embodiment, the coupling element is a bore 7823 adapted to accept and complimentary to the shaft proximate end 17 so as to extend over the shaft proximate end 17 coupling the needle assembly 831 to the shaft 16. In other embodiments, the bore 723 is adapted to be complimentary to and register with registration elements such as, but not limited to, “D” shaped profile and groove in the proximate end 17 of the shaft 16. In an embodiment in accordance with the present invention, the coupling post 827 comprises a resilient material so as to slip onto and couple in urging engagement with the proximal end 17 of the shaft 16.

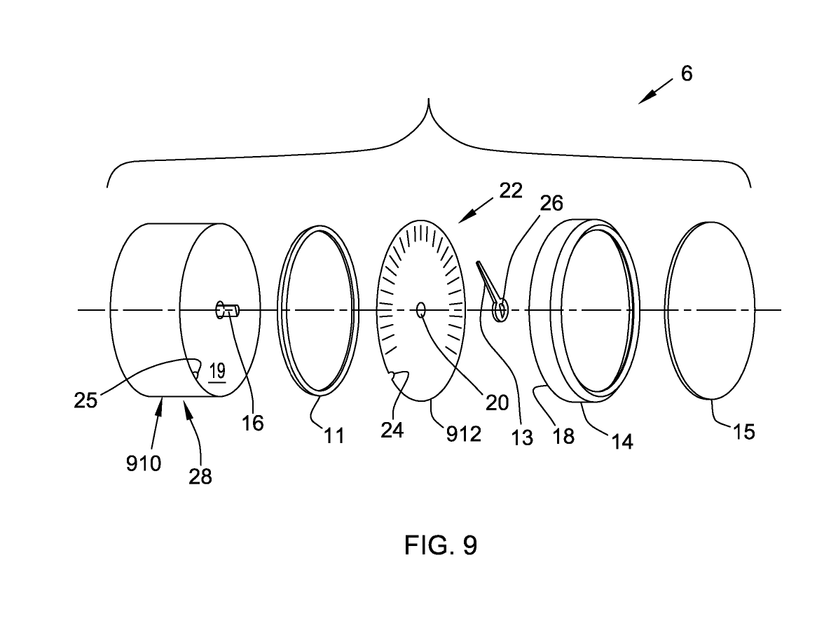

FIG. 9 is a perspective view of a gage 6 comprising a housing 910 and dial 912, in accordance with an embodiment of the present invention. The gage 6 is substantially the same as the embodiment of FIG. 1 wherein the bezel 18 is adapted for removable coupling with the housing 910 and the dial 912 is adapted for removable coupling with the face 19 with the shaft 16 about the dial aperture 20. The dial 912 further comprises a dial registration element 24 in the form of a notch and the face 19 further comprises a face registration element 25 in the form of a protrusion. The dial registration element 24 is adapted to register with the face registration element 25 so as to key the dial 912 with the housing face 19 to prevent the dial 12 from rotating relative to the face 19 and to ensure proper alignment with the housing 910 and the needle 13. Establishing proper alignment of the shaft 16 with the needle 13 and the dial 912 with the face 19 removes the necessity of providing a means to adjust or “zero” the needle 13 to the dial 912.

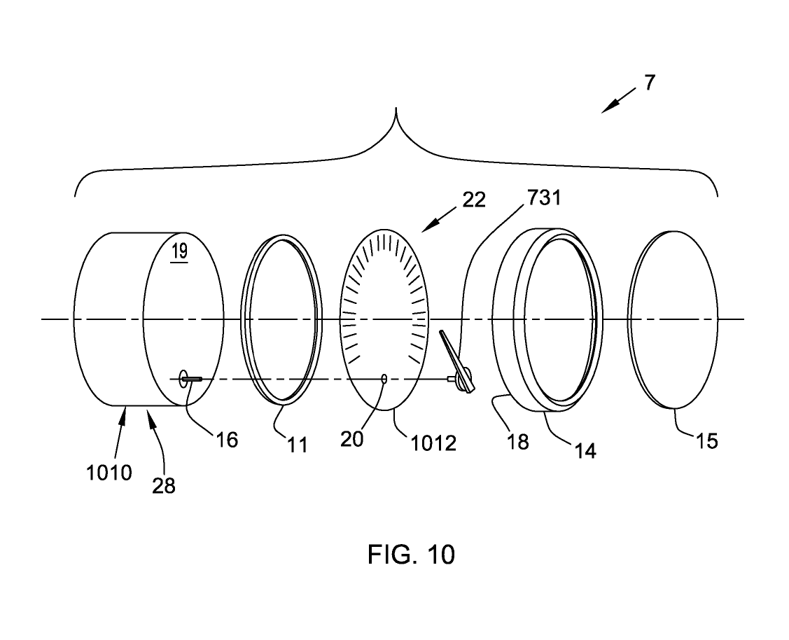

FIG. 10 is a perspective view of a gage 7, in accordance with an embodiment of the present invention. The gage 7 is substantially the same as the embodiment of FIG. 1 wherein the bezel 18 is adapted for removable coupling with a housing 1010 and a dial 1012 is adapted for removable coupling with the face 19 with the shaft 16 about the dial aperture 20. The shaft 16 is offset from the axis of the face 19. The aperture 20 is also offset from the axis of the dial 1012 to cooperate with the shaft 16. It is understood that the location of the shaft 16 about the face 19 is a matter of design and aesthetic preference, suitable for a particular purpose.

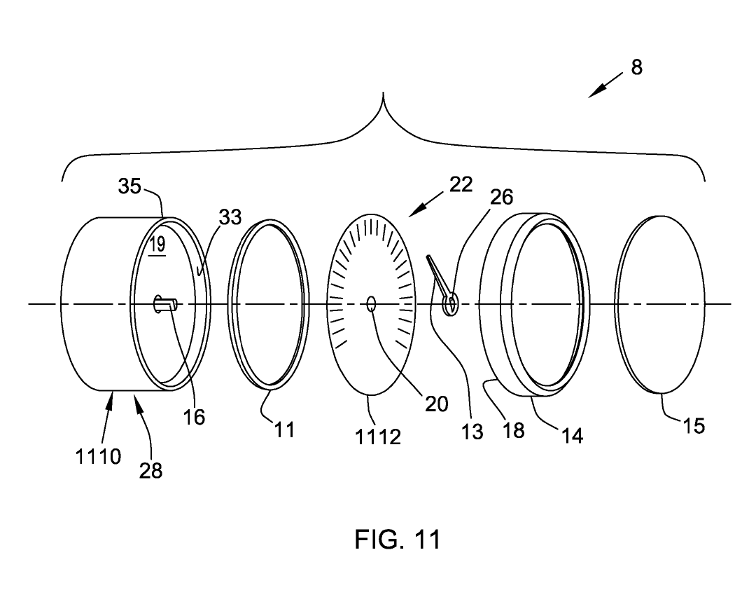

FIG. 11 is a perspective view of a gage 8, in accordance with an embodiment of the present invention. The gage 8 is substantially the same as the embodiment of FIG. 1 wherein the bezel 18 is adapted for removable coupling with a housing 1110 and a dial 1112 is adapted for removable coupling with the face 19 with the shaft 16 about the dial aperture 20. The housing 1110 further comprises a dial bore 33 extending from a housing proximal edge 35. The dial bore 33 is adapted to accept the dial 1112 therein adjacent the face 19.

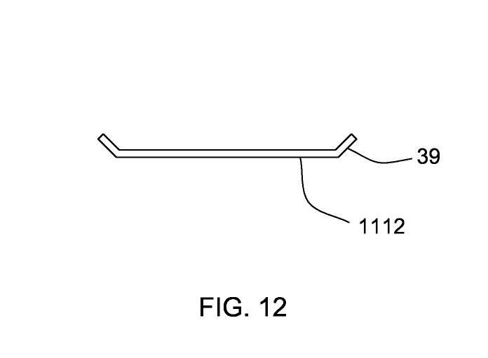

FIG. 12 is a side view of the dial 1112 of the embodiment shown in FIG. 11, in accordance with the present invention. The dial 1112 comprises a bore-engaging flange 39 about the perimeter of the dial 1112. The flange 39 has a diameter adapted for sliding and urging engagement with the dial bore 33 of the housing 1110. The engagement of the flange 39 and the dial bore 33 is adapted to provide a snug, removable coupling of the dial 1112 with the housing 1110.

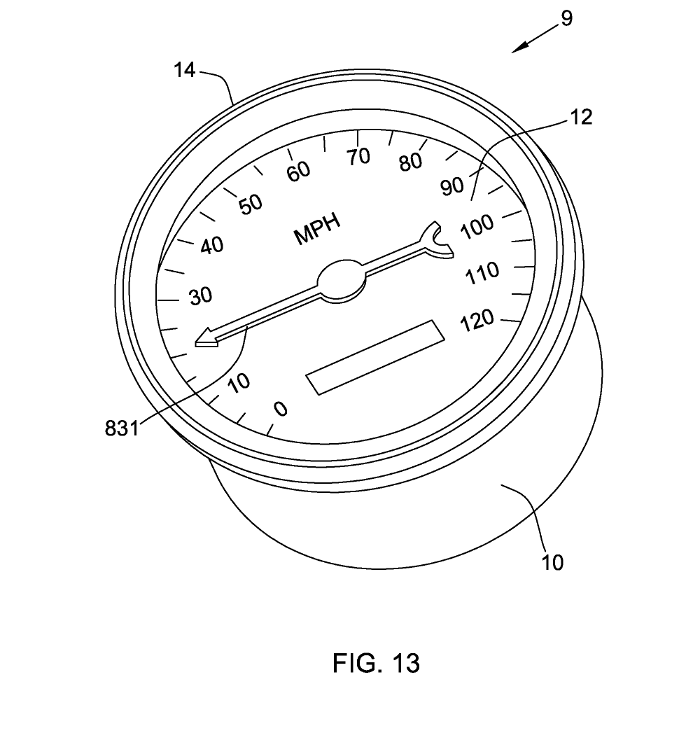

FIG. 13 is a perspective view of a gage 9 in accordance with an embodiment of the present invention. The gage 9 comprises a housing 10, dial 12, indicator needle 813, bezel ring 14 and crystal 15. The housing 10 is generally cylindrical defining a face which is hidden from view by the dial 12. The housing 10 generally houses the internal components (not shown) of the gage 9. A shaft 16, hidden from view by the indicator needle 813, extends forwardly beyond the face and the dial 12 so that the indicator needle 813 may be coupled thereon.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A gage comprising:
a housing defining a face;
a shaft extending beyond the face;
a dial provided adjacent the face, the dial comprising a dial aperture coaxially located with the shaft, the shaft extending through the dial aperture;
an indicator needle removably coupled to the shaft, the needle further comprising a needle coupling element, the shaft extending on the needle coupling element in removable engagement, the shaft having a predetermined cross-sectional shape that is adapted to register with a shape of the needle coupling element;
a bezel ring; and
a crystal, wherein the bezel ring is removably coupled to the housing, wherein the bezel ring removably couples the crystal to the housing.

2. The gage of claim 1 further comprising a sealing ring disposed between the housing and the bezel ring so as to inhibit the infiltration of dust within the housing and/or on the dial and needle.

3. The gage of claim 1, the housing comprising an outer side including at least one tapered notch, the bezel ring comprising at least one camming element, the camming element engages the tapered notch such that when the bezel ring is rotated relative to the housing, the camming element engages the notch urging the bezel ring onto and in secure removable engagement with the housing.

4. The gage of claim 3, the housing further comprising a snap notch provided in the tapered notch in cooperative engagement with the camming element therein to provide removable capture of the camming element.

5. The gage of claim 1, the housing comprising an outer side including a capture notch, the bezel ring comprising at least one engagement element in cooperative engagement with the capture notch such that when the bezel ring is pushed in urging engagement onto the housing, the engagement element engages the capture notch in a snap-on engagement such that the bezel ring is provided with secure removable engagement with the housing.

6. The gage of claim 1, the housing and the bezel ring comprise complementary helical threaded features so as to provide threaded engagement therebetween.

7. The gage of claim 1, the shaft comprising a proximal end having D-shaped profile and the needle coupling element comprising a complimentary D-shaped needle aperture, the shaft proximate end extending through the needle aperture, the shaft proximal end in registration with the needle aperture so as to prevent the needle from rotating relative to the shaft, the gage further comprising a coupling element coupling the needle to the shaft, the coupling element comprising a bore complimentary to the shaft proximate end so as to extend over the shaft proximate end coupling the needle to the shaft.

8. The gage of claim 7, the coupling element comprising a resilient material so as to slip onto and couple in urging engagement with the proximal end of the shaft.

9. The gage of claim 1, the shaft comprises a proximal end including a groove extending along the shaft from the proximal end, the needle coupling element comprising a complementary needle aperture including a protrusion, the shaft extending through the needle aperture, the groove in registration with the protrusion of the needle aperture, the cooperation of the groove and the protrusion aligning the needle to the shaft and preventing the needle from rotating relative to the shaft, the gage further comprising a coupling element coupling the needle to the shaft, the coupling element comprising a bore complimentary to the shaft proximate end so as to extend over the shaft proximate end coupling the needle to the shaft.

10. The gage of claim 9, the coupling element comprising a resilient material so as to slip onto and couple in urging engagement with the proximal end of the shaft.

11. The gage of claim 1, the needle coupling element in the form of a coupling post comprising a coupling element adapted to couple with the shaft of the housing.

12. The gage of claim 11, wherein the coupling element is a bore having a complimentary profile with the shaft proximate end so as to extend over the shaft proximate end couple the needle to the shaft.

13. The gage of claim 11, wherein the complimentary profile is D-shaped profile.

14. The gage of claim 1, the dial further comprising a dial registration element in the form of a notch and the face further comprising a face registration element in the form of a protrusion, the dial registration element in registration with the face registration element so as to align the dial with the housing face and to prevent the dial from rotating relative to the face.

15. The gage of claim 1, the housing further comprising a dial bore extending from a housing proximal edge, the dial disposed within the dial bore and adjacent the face.

16. The gage of claim 15, the dial comprising a bore-engaging flange about the perimeter of the dial, the flange having a diameter adapted for sliding and urging engagement with the dial bore of the housing.

17. A gage comprising:
a housing defining a face;
a shaft extending beyond the face;
a dial provided adjacent the face, the dial comprising a dial aperture coaxially located with the shaft, the shaft extending through the dial aperture;
an indicator needle removably coupled to the shaft, the needle further comprising a needle coupling element, the shaft extending on the needle coupling element in removable engagement, the shaft having a predetermined cross-sectional shape that is adapted to register with a shape of the needle coupling element;
a bezel ring; and
a crystal, wherein the bezel ring is removably coupled to the housing, wherein the bezel ring removably couples the crystal to the housing,
the housing comprising an outer side including at least one tapered notch, the bezel ring comprising at least one camming element, the camming element engages the tapered notch such that when the bezel ring is rotated relative to the housing, the camming element engages the notch urging the bezel ring onto and in secure removable engagement with the housing,
the dial further comprising a dial registration element in the form of a notch and the face further comprising a face registration element in the form of a protrusion, the dial registration element in registration with the face registration element so as to align the dial with the housing face and to prevent the dial from rotating relative to the face.
